(19) United States
(12) Patent Application Publication
(10) Pub. No.: US 2026/0048595 A1
(43) Pub. Date: Feb. 19, 2026

(54) DRYING APPARATUS AND PRINTING APPARATUS

(71) Applicant: SEIKO EPSON CORPORATION, Tokyo (JP)

(72) Inventors: Hideto YAMASHITA, SUWA-SHI (JP); Yusuke YAMAZAKI, SHIOJIRI-SHI (JP); Tsuneyuki SASAKI, MATSUMOTO-SHI (JP)

(21) Appl. No.: 19/302,196

(22) Filed: Aug. 18, 2025

(30) Foreign Application Priority Data
Aug. 19, 2024 (JP) 2024-137639

(51) Int. Cl. B41J 11/00; B41M 7/00; F26B 3/28; F26B 3/30; F26B 13/10; F26B 21/12

(52) U.S. Cl. CPC B41J 11/00216; B41J 11/00222; B41J 11/00224; B41M 7/009; F26B 3/283; F26B 3/30; F26B 13/108; F26B 21/12

(57) ABSTRACT

A drying apparatus includes a drying furnace which a medium to be conveyed enters, a heater configured to heat the medium in the drying furnace, an exhaust section configured to exhaust air from the drying furnace, and a movable section configured to move, wherein an intake port through which air flows from an outside of the drying furnace into the drying furnace opens in the drying furnace, the exhaust section includes a duct extending from the drying furnace and a fan configured to exhaust the air from an inside of the drying furnace toward the outside of the drying furnace through the duct, and the movable section moves to thereby adjust at least one of an intake volume of the air inflowing through the intake port and an exhaust volume of the air discharged from the drying furnace.

The present application is based on, and claims priority from JP Application Serial Number 2024-137639, filed Aug. 19, 2024, the disclosure of which is hereby incorporated by reference herein in its entirety.

### BACKGROUND

### 1. Technical Field

The present disclosure relates to a drying apparatus and a printing apparatus.

### 2. Related Art

JP-A-2020-2473 describes a drying apparatus including a heater that heats a medium and an exhaust section that exhausts air. The drying apparatus heats the medium with the heater and discharges vapor generated from the medium with the exhaust section to thereby dry the medium.

JP-A-2020-2473 is an example of the related art.

In such a drying apparatus, excess or deficiency may occur in the exhaust volume of the drying apparatus in some cases depending on the installation environment. When the drying apparatus is installed in a factory, there is a possibility that excess or deficiency occurs in the exhaust volume of the drying apparatus depending on the exhaust performance of the factory. When the excess or the deficiency occurs in the exhaust volume of the drying apparatus, there is a possibility that the drying apparatus fails to appropriately dry the medium. For example, when the exhaust volume of the drying apparatus is insufficient, the medium may be excessively heated due to an increase in temperature in the drying apparatus. When the exhaust volume of the drying apparatus is excessive, the temperature in the drying apparatus decreases, and thus there is a concern that drying of the medium may be insufficient.

### SUMMARY

A drying apparatus configured to solve the problems described above includes a drying furnace which a medium to be conveyed enters, a heater configured to heat the medium in the drying furnace, an exhaust section configured to exhaust air from the drying furnace, and a movable section configured to move, wherein an intake port through which air flows from the outside of the drying furnace into the drying furnace opens in the drying furnace, the exhaust section includes a duct extending from the drying furnace and a fan configured to exhaust the air from the inside of the drying furnace toward the outside of the drying furnace through the duct, and the movable section moves to thereby adjust at least one of an intake volume of the air inflowing through the intake port and an exhaust volume of the air discharged from the drying furnace.

A drying apparatus configured to solve the problems described above includes a drying furnace which a medium to be conveyed enters, a heater configured to heat the medium in the drying furnace, an exhaust section configured to exhaust air from the drying furnace, and a movable section configured to move, wherein an intake port through which air flows from the outside of the drying furnace into the drying furnace opens in the drying furnace, the exhaust section includes a duct extending from the drying furnace and a fan configured to exhaust the air from the inside of the drying furnace toward the outside of the drying furnace through the duct, and the movable section moves to thereby adjust at least one of a volume and a wind speed of air flowing along the medium in the drying furnace.

A printing apparatus configured to solve the problems described above includes a printing section configured to print an image on a medium, a drying furnace which the medium printed enters, a heater configured to heat the medium in the drying furnace, an exhaust section configured to exhaust air from the drying furnace, and a movable section configured to move, wherein an intake port through which air flows from the outside of the drying furnace into the drying furnace opens in the drying furnace, the exhaust section includes a duct extending from the drying furnace and a fan configured to exhaust the air from the inside of the drying furnace toward the outside of the drying furnace through the duct, and the movable section moves to thereby adjust at least one of an intake volume of the air inflowing through the intake port and an exhaust volume of the air discharged from the drying furnace.

A printing apparatus configured to solve the problems described above includes a printing section configured to print an image on a medium, a drying furnace which the medium printed enters, a heater configured to heat the medium in the drying furnace, an exhaust section configured to exhaust air from the drying furnace, and a movable section configured to move, wherein an intake port through which air flows from the outside of the drying furnace into the drying furnace opens in the drying furnace, the exhaust section includes a duct extending from the drying furnace and a fan configured to exhaust the air from the inside of the drying furnace toward the outside of the drying furnace through the duct, and the movable section moves to thereby adjust at least one of a volume and a wind speed of air flowing along the medium in the drying furnace.

### BRIEF DESCRIPTION OF THE DRAWINGS

FIG. 1 is a diagram showing an embodiment of a printing system.

FIG. 2 is a cross-sectional view showing an embodiment of a drying apparatus.

FIG. 3 is a perspective view of the drying apparatus.

FIG. 4 is a cross-sectional view showing a modified example of the drying apparatus.

FIG. 5 is a perspective view showing a modified example different from the modified example shown in FIG. 4.

FIG. 6 is a perspective view showing a modified example different from the modified examples shown in FIGS. 4 and 5.

FIG. 7 is a perspective view showing a modified example different from the modified examples shown in FIGS. 4, 5 and 6.

FIG. 8 is a cross-sectional view of a drying apparatus shown in FIG. 7.

FIG. 9 is a perspective view showing a modified example different from the modified examples shown in FIGS. 4, 5, 6 and 7.

FIG. 10 is a cross-sectional view showing a modified example different from the modified examples shown in FIGS. 4, 5, 6, 7 and 9.

FIG. 11 is a cross-sectional view showing a modified example different from the modified examples shown in FIGS. 4, 5, 6, 7, 9 and 10.

FIG. 12 is a cross-sectional view showing a modified example different from the modified examples shown in FIGS. 4, 5, 6, 7, 9, 10 and 11.

### DESCRIPTION OF EMBODIMENTS

An embodiment of a printing system including a printing apparatus and a drying apparatus will hereinafter be described with reference to the drawings.

### Printing System

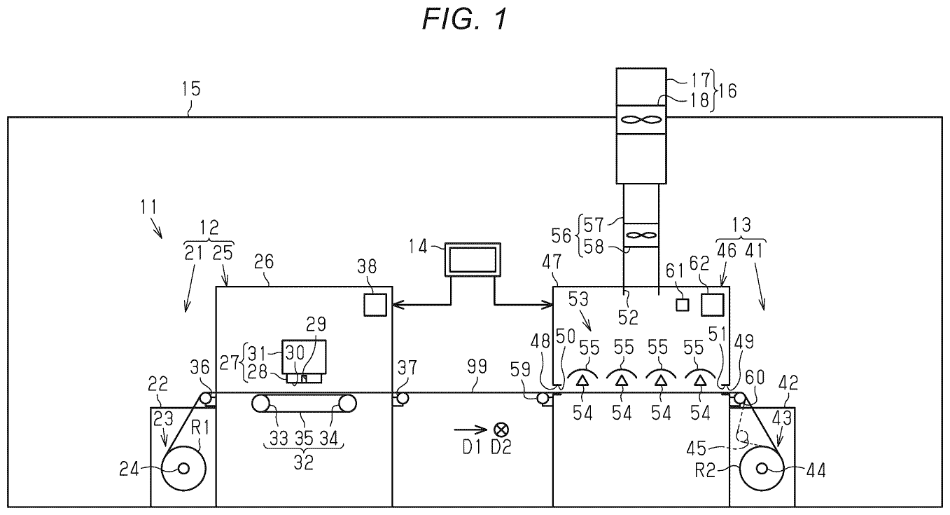

As shown in FIG. 1, a printing system 11 includes a printing apparatus 12 and a drying apparatus 13. The printing apparatus 12 is configured to print an image on a medium 99. The printing apparatus 12 is, for example, an inkjet printer that prints an image such as characters and pictures by ejecting ink, which is an example of a liquid, onto the medium 99 such as paper or cloth. The liquid is ink containing a solvent such as glycerin or water. The drying apparatus 13 is configured to dry the medium 99 printed. Specifically, the drying apparatus 13 dries the medium 99 by heating the medium 99. The printing system 11 performs printing and drying on the medium 99 as a long medium extending over the printing apparatus 12 and the drying apparatus 13. The printing apparatus 12 and the drying apparatus 13 may cooperate with each other by transmitting signals to each other.

The printing apparatus 12 and the drying apparatus 13 are arranged side by side in a conveyance direction D1. The conveyance direction D1 is a direction in which the medium 99 is conveyed from the printing apparatus 12 to the drying apparatus 13. In one example, the printing apparatus 12 and the drying apparatus 13 may be arranged at an interval in the conveyance direction D1. In this case, a user can enter an area between the printing apparatus 12 and the drying apparatus 13.

The printing system 11 includes an input section 14. The input section 14 is an interface for inputting information to the printing system 11. The user operates the printing system 11 by operating the input section 14. The input section 14 is, for example, a touch panel. The input section 14 may include a button, a lever, a switch, and the like. The input section 14 may be attached to the printing apparatus 12 or may be attached to the drying apparatus 13. The printing apparatus 12 may include the input section 14, and the drying apparatus 13 may include the input section 14. Each of the printing apparatus 12 and the drying apparatus 13 may include the input section 14.

The printing system 11 may be installed in a factory 15. The factory 15 includes an exhaust mechanism 16. The exhaust mechanism 16 is configured to exhaust air from the inside of the factory 15 to the outside of the factory 15. The exhaust mechanism 16 includes, for example, an exhaust duct 17 and an exhaust fan 18. The exhaust duct 17 extends to communicate with the inside and the outside of the factory 15. The exhaust fan 18 is attached to the exhaust duct 17. The exhaust fan 18 is configured to blow air from the inside of the factory 15 toward the outside of the factory 15 so that the air is discharged through the exhaust duct 17.

The printing system 11 is coupled to the exhaust mechanism 16. In the printing system 11, vapor is generated due to printing on the medium 99 or drying of the medium 99. In particular, the vapor is generated due to the drying apparatus 13 drying the medium 99. Therefore, the exhaust air from the printing system 11 contains the vapor. When the exhaust air from the printing system 11 is retained in the factory 15, there is a possibility that the vapor enters the printing system 11 or affects an operator in the factory 15. Therefore, by the exhaust mechanism 16 being coupled to the printing system 11, the exhaust air from the printing system 11 is discharged to the outside of the factory 15. The exhaust mechanism 16 may be coupled not only to the printing system 11 but also to other apparatuses, systems, and so on. The exhaust mechanism 16 may be a mechanism that collectively discharges exhaust air from apparatuses, systems, and so on installed in the factory 15.

### Printing Apparatus

The printing apparatus 12 may include a feeding unit 21. The feeding unit 21 is configured to feed the medium 99. The feeding unit 21 feeds the medium 99 from a roll body, for example. The roll body is an article formed of the medium 99 is wound to be stacked.

The feeding unit 21 may include a feeding case 22. The feeding case 22 houses a first roll body R1. The first roll body R1 is a roll body obtained by winding the medium 99 to be printed so as to be stacked.

The feeding unit 21 includes a feeder 23. The feeder 23 is configured to feed the medium 99 from the first roll body R1. In one example, the feeder 23 is housed in the feeding case 22.

The feeder 23 has a feeding shaft 24. The feeding shaft 24 rotatably supports the first roll body R1. The feeding shaft 24 may actively rotate, may be rotated, or may be fixed to the feeding case 22. When the first roll body R1 rotates, the medium 99 is fed from the first roll body R1. In the feeder 23, the first roll body R1 may be rotated by the feeding shaft 24 rotating, or may be rotated by the medium 99 being pulled.

The printing apparatus 12 includes a printing unit 25. The printing unit 25 is configured to perform printing on the medium 99. The printing unit 25 performs printing on the medium 99 fed from the feeding unit 21. The printing unit 25 may perform printing on the medium 99 fed from another apparatus.

The printing unit 25 includes a housing 26. The housing 26 is located adjacent to, for example, the feeding case 22. In one example, the housing 26 is aligned with the feeding case 22 in the conveyance direction D1. Specifically, the feeding case 22 and the housing 26 are arranged side by side in this order in the conveyance direction D1.

The printing unit 25 includes a printing section 27. The printing section 27 is housed in the housing 26. The printing section 27 prints an image on the medium 99. The printing section 27 performs printing on the medium 99 by ejecting a liquid onto the medium 99. The printing section 27 performs printing on the medium 99 fed from the feeder 23. The printing section 27 performs printing on the medium 99 conveyed in the housing 26.

The printing section 27 includes a head 28. The head 28 has a nozzle surface 30 on which one or more nozzles 29 open. The head 28 ejects the liquid from the nozzle 29 onto the medium 99. The nozzle surface 30 is opposed to the medium 99.

The printing section 27 may include a carriage 31. The head 28 is mounted on the carriage 31. The medium 99 is scanned with the carriage 31. That is, in one example, the head 28 is a serial head that performs printing over the width of the medium 99 by scanning the medium 99. The head 28 may be a line head capable of simultaneously ejecting the liquid over the width of the medium 99.

The printing unit 25 includes a conveyer 32. The conveyer 32 is configured to convey the medium 99. The conveyer 32 conveys the medium 99 in the housing 26. In one example, the conveyer 32 conveys the medium 99 in the conveyance direction D1. In one example, the conveyer 32 intermittently conveys the medium 99. This is because, in the example, the head 28 is a serial head. When the head 28 is a line head, the conveyer 32 may continuously convey the medium 99.

The conveyer 32 is housed in the housing 26. The conveyer 32 conveys the medium 99 fed from the feeder 23. The conveyer 32 may cause the feeder 23 to feed the medium 99 by pulling the medium 99 from the first roll body R1. The conveyer 32 is opposed to the printing section 27. In one example, the conveyer 32 is located immediately below the printing section 27.

The conveyer 32 includes a first pulley 33, a second pulley 34, and a belt 35. The first pulley 33 and the second pulley 34 are aligned in the conveyance direction D1, for example. The belt 35 is wound on the first pulley 33 and the second pulley 34 so as to be stretched therebetween. The belt 35 rotates together with the first pulley 33 and the second pulley 34.

The belt 35 supports the medium 99. Specifically, the belt 35 is configured to hold the medium 99. In one example, the belt 35 holds the medium 99 with an adhesive. The adhesive is applied to a surface of the belt 35. The medium 99 is attached to the belt 35 with the adhesive. Accordingly, the posture of the medium 99 is stabilized. For example, the belt 35 may hold the medium 99 with static electricity, or may hold the medium 99 with a negative pressure due to suction. When the belt 35 rotates while holding the medium 99, the medium 99 is conveyed. The conveyer 32 may convey the medium 99 not only with the belt 35, but also with, for example, a roller.

The printing unit 25 may include one or more printing guide rollers. In one example, the printing unit 25 includes a first printing guide roller 36 and a second printing guide roller 37. The printing guide rollers are configured to guide the medium 99. The printing guide rollers guide the medium 99 by coming into contact with the medium 99. The printing guide rollers guide the medium 99 from the feeding unit 21 to the printing unit 25 and guide the medium 99 from the printing apparatus 12 to the drying apparatus 13.

The printing guide rollers may be located inside the housing 26 or may be located outside the housing 26. In one example, the first printing guide roller 36 and the second printing guide roller 37 are located outside the housing 26. For example, the first printing guide roller 36 guides the medium 99 such that the medium 99 is supplied from the outside of the housing 26 into the housing 26. In one example, the first printing guide roller 36 guides, into the housing 26, the medium 99 fed from the feeder 23. The second printing guide roller 37 guides the medium 99 so as to be discharged from the inside of the housing 26 to the outside of the housing 26, for example. Specifically, the second printing guide roller 37 guides the medium 99 which is printed to the outside of the housing 26.

The printing unit 25 includes a printing controller 38. The printing controller 38 controls the printing unit 25. Specifically, the printing controller 38 controls the printing section 27 and the conveyer 32. The printing controller 38 may control the feeding unit 21 in addition to the printing unit 25. The printing controller 38 may control, for example, the feeder 23.

The printing controller 38 may be configured with one or more processors that execute various types of processing according to computer programs. The printing controller 38 may be configured with one or more dedicated hardware circuits such as an ASIC that executes at least some of the various types of processing. The printing controller 38 may be configured with a circuit including a combination of a processor and a hardware circuit. The processor includes a CPU and memory devices such as a RAM and a ROM. The memory devices store program codes or commands configured to cause the CPU to execute the processing. The memory device, that is, a computer-readable medium includes any readable medium that can be accessed by a general-purpose or dedicated computer.

The printing controller 38 may communicate with the drying apparatus 13. The printing controller 38 may transmit various signals to the drying apparatus 13. The printing controller 38 may notify the drying apparatus 13 of the status of the printing apparatus 12 by transmitting signals thereto. The printing controller 38 may receive various signals from the drying apparatus 13. The printing controller 38 may figure out the status of the drying apparatus 13 by receiving signals from the drying apparatus 13.

### Drying Apparatus

The drying apparatus 13 may include a winding unit 41. The winding unit 41 is configured to wind the medium 99. The winding unit 41 forms a roll body by winding the medium 99.

The winding unit 41 may include a winding case 42. The winding case 42 houses a second roll body R2. The second roll body R2 is a roll body obtained by winding the medium 99 having been dried so as to be stacked.

The winding unit 41 includes a winder 43. The winder 43 is configured to wind the medium 99. The winder 43 winds the medium 99 having been dried. In one example, the winder 43 is housed in the winding case 42.

The winder 43 includes a winding shaft 44. The winding shaft 44 rotatably supports the second roll body R2. By the winding shaft 44 rotating, the medium 99 is wound around the winding shaft 44. As the winding shaft 44 rotates, the second roll body R2 rotates. The medium 99 is conveyed in the drying apparatus 13 by being wound by the winder 43.

The winder 43 is driven to wind the medium 99 at a higher speed than that of the conveyer 32. That is, the winder 43 is driven such that the winding speed is faster than the conveyance speed. Accordingly, tension is applied to the medium 99 between the conveyer 32 and the winder 43. By applying the tension to the medium 99, the posture of the medium 99 is stabilized. In one example, the medium 99 is easily separated from the belt 35 by applying the tension to the medium 99.

The winder 43 may include a dancer roller 45. The dancer roller 45 may be located inside the winding case 42 or may be located outside the winding case 42. The medium 99 is wound around the dancer roller 45. Specifically, the medium 99 to be wound around the winding shaft 44 is wound around the dancer roller 45. The dancer roller 45 is configured to be displaced. The dancer roller 45 is displaced to thereby adjust the tension applied to the medium 99. Accordingly, it becomes easy for the winding shaft 44 to stably wind the medium 99. Similarly, the feeder 23 may include the dancer roller 45.

The drying apparatus 13 includes a drying unit 46. The drying unit 46 is configured to dry the medium 99. The drying unit 46 dries the medium 99 printed by the printing apparatus 12. The medium 99 is dried by the drying unit 46 and is then wound by the winding unit 41.

The drying unit 46 includes a drying furnace 47. The drying furnace 47 is located adjacent to the winding case 42, for example. In one example, the drying furnace 47 is aligned with the winding case 42 in the conveyance direction D1. Specifically, the drying furnace 47 and the winding case 42 are arranged side by side in this order in the conveyance direction D1. The medium 99 which is conveyed enters the drying furnace 47. Specifically, the medium 99 conveyed from the printing apparatus 12 enters the drying furnace 47. The medium 99 which is printed enters the drying furnace 47. In the drying furnace 47, the medium 99 is conveyed by the conveyer 32 and the winder 43.

One or more passage ports open in the drying furnace 47. In one example, a first passage port 48 and a second passage port 49 open in the drying furnace 47. The passage port is an opening through which the medium 99 passes. The medium 99 enters the drying furnace 47 through the first passage port 48. The medium 99 is discharged from the drying furnace 47 through the second passage port 49. The first passage port 48 opens on a surface which is a surface of the drying furnace 47, and is opposed to the printing apparatus 12. The second passage port 49 opens on a surface which is a surface of the drying furnace 47, and is opposite to the surface opposed to the printing apparatus 12. For example, the second passage port 49 opens on a surface which is a surface of the drying furnace 47, and is adjacent to the winding unit 41.

One or more intake ports open in the drying furnace 47. In one example, a first intake port 50 and a second intake port 51 open in the drying furnace 47. The intake port is an opening through which air flows from the outside of the drying furnace 47 into the drying furnace 47. The drying furnace 47 sucks the air through the intake port. The intake port may be an opening common to the passage port or may be a different opening independent of the passage port. In one example, the first intake port 50 is an opening common to the first passage port 48. The second intake port 51 is an opening common to the second passage port 49.

One or more exhaust ports 52 open in the drying furnace 47. In one example, a single exhaust port 52 opens in the drying furnace 47. The exhaust port 52 is an opening through which the air flows from the inside of the drying furnace 47 to the outside of the drying furnace 47. The drying furnace 47 exhausts the air through the exhaust port 52. The exhaust port 52 is an opening different from the passage port and the intake port. The exhaust port 52 opens on, for example, an upper surface of the drying furnace 47.

The drying unit 46 includes a heater 53. The heater 53 is housed in the drying furnace 47. The heater 53 is configured to heat the medium 99. The heater 53 heats the medium 99 in the drying furnace 47. The heater 53 is located to face the medium 99. By the heater 53 heating the medium 99, the liquid adhering to the medium 99 evaporates. Accordingly, the medium 99 is dried. As a result, the image is fixed to the medium 99.

The heater 53 includes one or more heating members 54. In one example, the heater 53 includes four heating members 54. The heating members 54 are located to face the medium 99. The heating members 54 are located to face a printed surface of the medium 99. In one example, the heating members 54 are located to face an upper surface of the medium 99. The four heating members 54 are arranged side by side in the conveyance direction D1. The four heating members 54 are arranged side by side along the medium 99 extending in the drying furnace 47. The heating member 54 is not limited to an infrared heater, and may be, for example, a blower that blows hot air onto the medium 99.

The heating member 54 is configured to heat the medium 99. The heating member 54 is, for example, an infrared heater. The heating member 54 heats the medium 99 by irradiating the medium 99 with infrared rays. The heating member 54 irradiates the printed surface of the medium 99 with the infrared rays.

The heating member 54 is configured to heat the medium 99 over the width thereof. In one example, the heating member 54 extends in a width direction D2. The width direction D2 is a direction different from the conveyance direction D1. The width direction D2 is a direction different from the vertical direction. The width direction D2 is a direction serving as an index indicating the width of the medium 99. The heating member 54 extends in the width direction D2 to thereby irradiate the medium 99 with the infrared rays over the width thereof. The heating member 54 is configured to be larger than the entire width of the medium 99 in the width direction D2, for example. Specifically, the heating member 54 is configured to be longer than the maximum width of the medium 99 which the drying apparatus 13 can deal with.

The heater 53 may include one or more reflection plates 55. In one example, the heater 53 includes the same number of reflection plates 55 as the number of heating members 54. The heater 53 includes four reflection plates 55. The reflection plates 55 are located so as to reflect the infrared rays generated from the heating members 54 toward the medium 99. The reflection plates 55 are located, for example, immediately above the heating members 54.

The drying unit 46 includes an exhaust section 56. The exhaust section 56 is coupled to the drying furnace 47. The exhaust section 56 is configured to exhaust the air from the drying furnace 47. Specifically, the exhaust section 56 exhausts the air from the drying furnace 47 through the exhaust port 52.

The exhaust section 56 includes a duct 57. The duct 57 extends from the drying furnace 47. The duct 57 is attached to the drying furnace 47. The duct 57 is coupled to the drying furnace 47 so as to communicate with the inside of the drying furnace 47 with the exhaust port 52. The duct 57 communicates with the inside and the outside of the drying furnace 47.

The duct 57 may be coupled to the exhaust mechanism 16. In one example, the duct 57 is coupled to the exhaust duct 17. The exhaust section 56 exhausts the air from the drying furnace 47 toward the exhaust mechanism 16. The exhaust section 56 exhausts the air from the inside of the drying furnace 47 to the outside of the factory 15 through the exhaust mechanism 16. The duct 57 may extend to the outside of the factory 15.

The exhaust section 56 includes a fan 58. The fan 58 is configured to exhaust the air from the inside of the drying furnace 47 toward the outside of the drying furnace 47 through the duct 57. The fan 58 blows the air from the inside of the drying furnace 47 toward the outside of the drying furnace 47. The fan 58 is attached to the duct 57. The fan 58 is located in the duct 57. In one example, the fan 58 exhausts the air from the drying furnace 47 toward the exhaust mechanism 16. The fan 58 is driven to rotate at a predetermined speed, for example. The air is sent to the fan 58, and is then discharged to the outside of the factory 15 through the exhaust mechanism 16.

The drying unit 46 may include one or more drying guide rollers. In one example, the drying unit 46 includes a first drying guide roller 59 and a second drying guide roller 60. The drying guide rollers are configured to guide the medium 99 similarly to the printing guide rollers. The drying guide rollers guide the medium 99 by coming into contact with the medium 99. The drying guide rollers guide the medium 99 from the printing apparatus 12 to the drying apparatus 13, and guide the medium 99 from the drying unit 46 to the winding unit 41.

The drying guide roller may be located inside the drying furnace 47 or may be located outside the drying furnace 47. In one example, the first drying guide roller 59 and the second drying guide roller 60 are located outside the drying furnace 47. For example, the first drying guide roller 59 guides the medium 99 such that the medium 99 is supplied from the outside of the drying furnace 47 into the drying furnace 47. In one example, the first drying guide roller 59 guides the medium 99 conveyed from the printing apparatus 12 into the drying furnace 47. The first drying guide roller 59 guides the medium 99 so that the medium 99 enters the drying furnace 47 through the first passage port 48. The second drying guide roller 60 guides the medium 99 so that the medium 99 is discharged from the drying furnace 47 to the outside of the drying furnace 47, for example. Specifically, the second drying guide roller 60 guides the medium 99 which has been dried to the outside of the drying furnace 47. The second drying guide roller 60 guides the medium 99 so that the medium 99 is discharged from the drying furnace 47 through the second passage port 49.

The drying unit 46 may include a detector 61. The detector 61 is configured to detect the state of the drying apparatus 13. Specifically, the detector 61 is configured to detect the state inside the drying furnace 47. The detector 61 is located, for example, inside the drying furnace 47. The detector 61 may be located inside the duct 57. The detector 61 includes, for example, a sensor. The detector 61 may detect a wind speed in the drying furnace 47 or may detect a volume of the air flowing in the drying furnace 47. The detector 61 may detect the temperature in the drying furnace 47 or may detect the humidity in the drying furnace 47. The detector 61 may detect a vapor component in the drying furnace 47. Specifically, the detector 61 may detect a component of a solvent evaporated from the liquid. For example, when the liquid contains glycerin and water in the solvent, the detector 61 may detect glycerin and water.

The drying unit 46 includes a controller 62. The controller 62 controls the drying unit 46. Specifically, the controller 62 controls the heater 53 and the exhaust section 56. The controller 62 may control the winding unit 41 in addition to the drying unit 46. For example, the controller 62 may control the winder 43. The controller 62 may be configured with a processor, a hardware circuit, or a circuit including a combination thereof, similarly to the printing controller 38.

The controller 62 may be coupled to the detector 61. The controller 62 may determine whether the medium 99 is appropriately dried based on a detection result of the detector 61. For example, the controller 62 may determine that the medium 99 is to appropriately be dried when the wind speed in the drying furnace 47 is within a predetermined range. The controller 62 may determine that the medium 99 is to appropriately be dried when the volume of the air flowing in the drying furnace 47 is within a predetermined range. The controller 62 may determine that the medium 99 is to appropriately be dried when the temperature in the drying furnace 47 is within a predetermined range. The controller 62 may determine that the medium 99 is to appropriately be dried when the humidity in the drying furnace 47 is within a predetermined range. The controller 62 may determine that the medium 99 is to appropriately be dried when the vapor component in the drying furnace 47 is in a predetermined proportion.

The controller 62 may communicate with the printing apparatus 12. Specifically, the controller 62 communicates with the printing controller 38. The controller 62 transmits various signals to the printing controller 38. The controller 62 notifies the printing controller 38 of the status of the drying apparatus 13 by transmitting the signals thereto. The controller 62 receives various signals from the printing controller 38. The controller 62 can figure out the status of the printing apparatus 12 by receiving the signals from the printing controller 38. For example, the controller 62 may receive printing information from the printing controller 38. The printing information includes a printing speed with the printing section 27 and a conveyance speed with the conveyer 32. The printing information may include information representing the type of the liquid used for printing, information representing the type of the medium 99, and so on.

In the drying apparatus 13, the medium 99 is heated by the heater 53, and thus vapor is accumulated in the drying furnace 47. The medium 99 is appropriately dried by the exhaust section 56 discharging the air together with the vapor from the drying furnace 47 or the drying furnace 47 sucking the air from the intake port. For example, the exhaust section 56 exhausts the air from the drying furnace 47 or the drying furnace 47 sucks the air through the intake port, so that the inside of the drying furnace 47 is maintained in an environment suitable for drying the medium 99. The exhaust section 56 exhausts the air from the drying furnace 47 or the drying furnace 47 sucks the air through the intake port, so that the inside of the drying furnace 47 is maintained at a temperature suitable for drying the medium 99.

When excess or deficiency may occur in the exhaust volume from the drying furnace 47, there is a possibility that the medium 99 fails to be appropriately dried. For example, when the exhaust volume is excessive, the temperature in the drying furnace 47 tends to drop. In this case, there is a possibility that drying of the medium 99 becomes insufficient. When the exhaust volume is insufficient, the temperature in the drying furnace 47 tends to rise. In this case, there is a possibility that the medium 99 is excessively heated. Further, when the exhaust volume is insufficient, there is a possibility that the vapor leaks from the drying furnace 47 into the factory 15.

The exhaust volume from the drying furnace 47 is affected by a driving amount of the fan 58. When the driving amount of the fan 58 increases, the exhaust volume tends to increase. When the driving amount of the fan 58 decreases, the exhaust volume tends to decrease.

The exhaust volume from the drying furnace 47 may be affected by an environment in which the drying apparatus 13 is installed. For example, when the exhaust section 56 is coupled to the exhaust mechanism 16, the exhaust volume may be affected by the exhaust mechanism 16. When an exhaust performance of the exhaust mechanism 16 is low, there is a possibility that the exhaust volume is insufficient. This is because the exhaust mechanism 16 becomes a bottleneck. When the exhaust performance of the exhaust mechanism 16 is high, there is a possibility that the exhaust volume becomes excessive. Therefore, when the exhaust section 56 is coupled to the exhaust mechanism 16, it may be difficult to adjust the exhaust volume with the driving amount of the fan 58. Further, when the exhaust section 56 directly exhausts the air to the outside of the factory 15, the exhaust volume may be affected by an environment outside the factory 15. For example, depending on the weather, there is a possibility that excess or deficiency may occur in the exhaust volume. Therefore, even when the exhaust section 56 directly exhausts the air to the outside of the factory 15, it may be difficult to adjust the exhaust volume by the driving amount of the fan 58 in some cases.

The exhaust volume from the drying furnace 47 is affected by how easy it is to suction the air through the intake port. Specifically, how easy it is to suction the air flowing into the drying furnace 47 through the intake port affects the exhaust volume. When the air is easily taken in through the intake port, the intake volume tends to increase. When the intake volume is large, the exhaust volume tends to increase. When it is difficult to take in the air through the intake port, the intake volume tends to decrease. When the intake volume is small, the exhaust volume tends to decrease.

The exhaust volume from the drying furnace 47 is affected by how easy it is to exhaust the air through the exhaust port 52. Specifically, how easy it is to exhaust the air to be discharged from the drying furnace 47 through the exhaust port 52 affects the exhaust volume. The easier it is to exhaust the air through the exhaust port 52, the larger the exhaust volume tends to be. The more difficult it is to exhaust the air through the exhaust port 52, the smaller the exhaust volume tends to be.

The drying apparatus 13 adjusts the environment in the drying furnace 47 by adjusting how easy it is to suck the air, how easy it is to exhaust the air, or both thereof. That is, the drying apparatus 13 adjusts the environment in the drying furnace 47 by adjusting at least one of the intake volume and the exhaust volume. It can also be said that the drying apparatus 13 adjusts how easy it is for the air to flow in the drying apparatus 13 by adjusting the intake volume or adjusting the exhaust volume. The drying apparatus 13 appropriately dries the medium 99 by adjusting the intake volume or adjusting the exhaust volume.

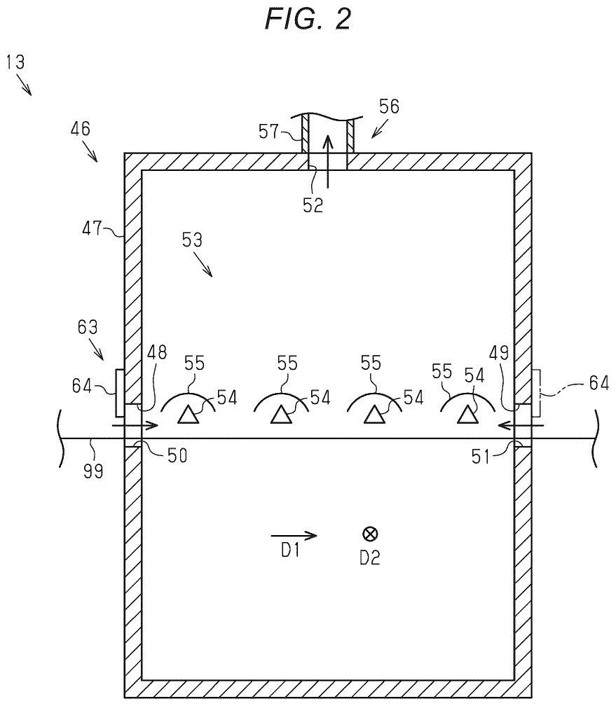

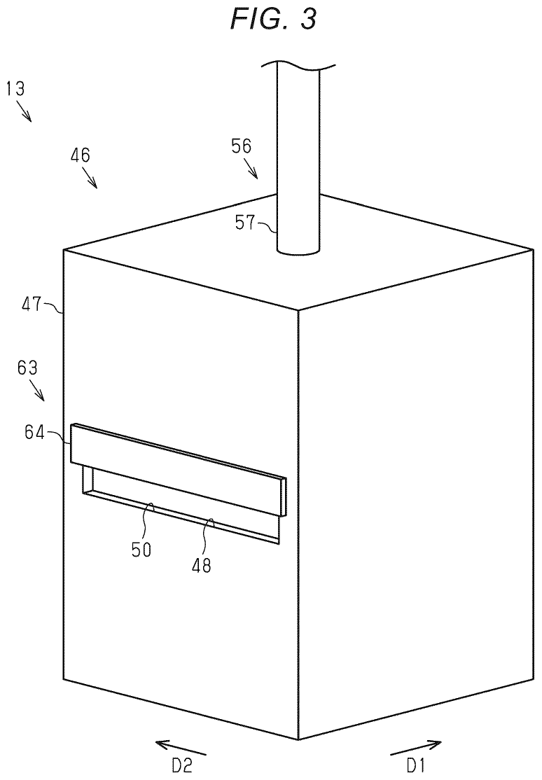

As shown in FIGS. 2 and 3, the drying unit 46 includes a movable section 63. The movable section 63 is configured to move. The movable section 63 is configured to move in the drying unit 46. The movable section 63 moves to thereby adjust at least one of the intake volume of the air inflowing through the intake port and the exhaust volume of the air discharged from the drying furnace 47. The movable section 63 may move to thereby adjust the intake volume. The movable section 63 may move to thereby adjust the exhaust volume. The movable section 63 may move to thereby adjust both the intake volume and the exhaust volume. It can also be said that the movable section 63 moves to thereby adjusts how easy it is for the air to flow in the drying furnace 47. The drying unit 46 appropriately dries the medium 99 by the movable section 63 adjusting at least one of the intake volume and the exhaust volume.

The movable section 63 may be configured to change a flow path resistance to the air inflowing through the intake port. The movable section 63 may move to thereby change the flow path resistance to the air inflowing through the intake port. When the flow path resistance increases, it becomes difficult to suck the air through the intake port. In this case, the intake volume decreases. When the flow path resistance decreases, it becomes easy to suck the air through the intake port. In this case, the intake volume increases. In this way, the movable section 63 may adjust the intake volume.

The movable section 63 may be configured to change a flow path resistance to the air discharged from the drying furnace 47. The movable section 63 may move to thereby change the flow path resistance to the air discharged from the drying furnace 47. When the flow path resistance increases, it becomes difficult to discharge the air through the exhaust port 52. In this case, the exhaust volume decreases. When the flow path resistance decreases, it becomes easy to exhaust the air through the exhaust port 52. In this case, the exhaust volume increases. In this way, the movable section 63 may adjust the exhaust volume.

The movable section 63 moves so that the medium 99 is appropriately dried in the drying furnace 47. The movable section 63 moves so that, for example, the inside of the drying furnace 47 becomes an appropriate environment when drying the medium 99. When the exhaust volume from the drying furnace 47 is insufficient, the movable section 63 moves so as to increase the intake volume or increase the exhaust volume. When the exhaust volume is insufficient, the temperature in the drying furnace 47 tends to rise. In contrast, by the movable section 63 moving so as to increase the intake volume or increase the exhaust volume, the temperature in the drying furnace 47 becomes difficult to rise. The movable section 63 moves so as to decrease the intake volume or decrease the exhaust volume when the exhaust volume is excessive. When the exhaust volume is excessive, the temperature in the drying furnace 47 tends to drop. In contrast, by the movable section 63 moving so as to decrease the intake volume or decrease the exhaust volume, the temperature in the drying furnace 47 becomes difficult to drop.

The movable section 63 may be controlled by the controller 62. The movable section 63 may be controlled by the controller 62 so as to automatically move. For example, the movable section 63 may be controlled by the controller 62 such that the medium 99 is appropriately dried. The movable section 63 may be configured to be manually moved by the user. For example, the movable section 63 may be manually moved such that the medium 99 is appropriately dried.

The movable section 63 may be controlled by the controller 62 based on the detection result of the detector 61. That is, the movable section 63 may be automatically moved by the controller 62 based on the detection result of the detector 61. The movable section 63 may be manually moved by the user based on the detection result of the detector 61.

When the wind speed in the drying furnace 47 is high, the movable section 63 may move so as to decrease the intake volume or decrease the exhaust volume. When the wind speed in the drying furnace 47 is high, the temperature in the drying furnace 47 tends to drop. In particular, when the wind speed of the air flowing along the medium 99 is high, the temperature of the medium 99 tends to drop. Therefore, drying of the medium 99 is likely to be insufficient. In contrast, by the movable section 63 moving so as to decrease the intake volume or decrease the exhaust volume, the temperature in the drying furnace 47 becomes difficult to drop.

When the wind speed in the drying furnace 47 is low, the movable section 63 may move so as to increase the intake volume or increase the exhaust volume. When the wind speed in the drying furnace 47 is low, the temperature in the drying furnace 47 tends to rise. In particular, when the wind speed of the air flowing along the medium 99 is low, the temperature of the medium 99 tends to rise. Therefore, the medium 99 is likely to be excessively heated. In contrast, by the movable section 63 moving so as to increase the intake volume or increase the exhaust volume, the temperature in the drying furnace 47 becomes difficult to rise.

When the volume of the air flowing in the drying furnace 47 is large, the movable section 63 may move so as to decrease the intake volume or decrease the exhaust volume. When the volume of the air flowing in the drying furnace 47 is large, the temperature in the drying furnace 47 tends to drop. In particular, when the volume of the air flowing along the medium 99 is large, the temperature of the medium 99 tends to drop. Therefore, drying of the medium 99 is likely to be insufficient. In contrast, by the movable section 63 moving so as to decrease the intake volume or decrease the exhaust volume, the temperature in the drying furnace 47 becomes difficult to drop.

When the volume of the air flowing in the drying furnace 47 is small, the movable section 63 may move so as to increase the intake volume or increase the exhaust volume. When the volume of the air flowing in the drying furnace 47 is small, the temperature in the drying furnace 47 tends to rise. In particular, when the volume of the air flowing along the medium 99 is small, the temperature of the medium 99 tends to rise. Therefore, the medium 99 is likely to be excessively heated. In contrast, by the movable section 63 moving so as to increase the intake volume or increase the exhaust volume, the temperature in the drying furnace 47 becomes difficult to rise.

When the temperature in the drying furnace 47 is high, the movable section 63 may move so as to increase the intake volume or increase the exhaust volume. Accordingly, the temperature in the drying furnace 47 becomes difficult to rise. When the temperature in the drying furnace 47 is low, the movable section 63 may move so as to decrease the intake volume or decrease the exhaust volume. Accordingly, the temperature in the drying furnace 47 becomes difficult to drop.

When the humidity in the drying furnace 47 is high, the movable section 63 may move so as to increase the intake volume or increase the exhaust volume. When the humidity in the drying furnace 47 is high, there is a possibility that the vapor is retained due to an insufficient exhaust volume. Therefore, there is a possibility that the medium 99 is excessively heated, or drying of the medium 99 stagnates. In contrast, by the movable section 63 moving so as to increase the intake volume or increase the exhaust volume, the humidity in the drying furnace 47 is likely to decrease.

When the humidity in the drying furnace 47 is low, the movable section 63 may move so as to decrease the intake volume or decrease the exhaust volume. When the humidity in the drying furnace 47 is low, there is a possibility that the temperature in the drying furnace 47 drops due to the excessive exhaust volume. Therefore, drying of the medium 99 is likely to be insufficient. In contrast, by the movable section 63 moving so as to decrease the intake volume or decrease the exhaust volume, the temperature in the drying furnace 47 becomes difficult to drop.

When the pressure in the drying furnace 47 is high, the movable section 63 may move so as to increase the intake volume or increase the exhaust volume. When the pressure in the drying furnace 47 is high, there is a possibility that the vapor is retained due to an insufficient exhaust volume. Therefore, there is a possibility that the medium 99 is excessively heated, or drying of the medium 99 stagnates. In contrast, by the movable section 63 moving so as to increase the intake volume or increase the exhaust volume, the vapor is likely to be discharged from the drying furnace 47.

When the pressure in the drying furnace 47 is low, the movable section 63 may move so as to decrease the intake volume or decrease the exhaust volume. When the pressure in the drying furnace 47 is low, there is a possibility that the temperature in the drying furnace 47 drops due to the excessive exhaust volume. Therefore, drying of the medium 99 is likely to be insufficient. In contrast, by the movable section 63 moving so as to decrease the intake volume or decrease the exhaust volume, the temperature in the drying furnace 47 becomes difficult to drop.

The movable section 63 may move so as to change the intake volume or change the exhaust volume based on the vapor component in the drying furnace 47. For example, when an amount of water vapor in the drying furnace 47 is large, the movable section 63 may move so as to decrease the intake volume or decrease the exhaust volume. In a liquid containing water and glycerin, water evaporates more easily than glycerin due to a difference in boiling point. Therefore, when the amount of the water vapor is large, there is a possibility that the evaporation of glycerin stagnates. In this case, there is a possibility that the temperature in the drying furnace 47 is excessively lowered. In contrast, by the movable section 63 moving so as to decrease the intake volume or decrease the exhaust volume, the temperature in the drying furnace 47 becomes difficult to drop.

The movable section 63 may be controlled by the controller 62 based on the printing information. That is, the movable section 63 may be automatically moved by the controller 62 based on the printing information. The movable section 63 may be manually moved by the user based on the printing information.

When the printing speed, the conveyance speed, or the like is high, the movable section 63 may move so as to decrease the intake volume or decrease the exhaust volume. When the printing speed, the conveyance speed, or the like is high, the heating time of the medium 99 tends to be short. Therefore, drying of the medium 99 is likely to be insufficient. In contrast, by the movable section 63 moving so as to decrease the intake volume or decrease the exhaust volume, the temperature in the drying furnace 47 is likely to rise. Accordingly, drying of the medium 99 is promoted.

The movable section 63 may include one or more covers 64. In one example, the movable section 63 includes a single cover 64. The cover 64 is attached to the drying furnace 47. The cover 64 moves to thereby change the flow path area of the intake port. The flow path area of the intake port is the effective area of the intake port through which the air can pass. When the flow path area of the intake port decreases, the flow path resistance to the air inflowing from the intake port increases. This tends to decrease the intake volume. When the flow path area of the intake port increases, the flow path resistance to the air inflowing from the intake port decreases. As a result, the intake volume tends to increase.

The cover 64 is attached so as to overlap the first intake port 50. The cover 64 moves so as to change the opening area of the first intake port 50. The cover 64 may be attached so as to overlap the second intake port 51. The cover 64 may move so as to change the opening area of the second intake port 51. The movable section 63 may include the cover 64 that changes the opening area of the first intake port 50 and the cover 64 that changes the opening area of the second intake port 51. In this case, the two covers 64 may be configured to move integrally or may be configured to move independently of each other.

The cover 64 is configured to slide in the vertical direction. This changes the flow path area of the intake port. In one example, the downward movement of the cover 64 reduces the flow path area of the first intake port 50. This decreases the intake volume. The upward movement of the cover 64 increases the flow path area of the first intake port 50. This increases the intake volume.

When the exhaust volume is insufficient, the cover 64 moves to thereby increase the flow path area of the intake port. Accordingly, the temperature in the drying furnace 47 becomes difficult to rise. When the exhaust volume is excessive, the cover 64 moves to thereby reduce the flow path area of the intake port. Accordingly, the temperature in the drying furnace 47 becomes difficult to drop.

### Functions and Advantages of Embodiment

Then, functions and advantages of the embodiment described above will be described.

(1) The movable section 63 moves to thereby adjust at least one of the intake volume of the air inflowing through the intake port and the exhaust volume of the air exhausted from the drying furnace 47. When the intake volume changes or the exhaust volume changes, the temperature in the drying furnace 47 rises or drops. For example, when the intake volume increases, the temperature in the drying furnace 47 tends to drop. When the intake volume decreases, the temperature in the drying furnace 47 tends to rise. When the exhaust volume increases, the temperature in the drying furnace 47 tends to drop. When the exhaust volume decreases, the temperature in the drying furnace 47 tends to rise. According to the above configuration, when the exhaust volume is insufficient, the movable section 63 moves so as to increase the intake volume or increase the exhaust volume, so that the temperature in the drying furnace 47 becomes difficult to rise. When the exhaust volume is excessive, the movable section 63 moves so as to decrease the intake volume or decrease the exhaust volume, so that the temperature in the drying furnace 47 becomes difficult to drop. Accordingly, the drying apparatus 13 can appropriately dry the medium 99.

(2) The movable section 63 moves to thereby change the flow path resistance to the air inflowing through the intake port. When the flow path resistance increases due to the movement of the movable section 63, the intake volume tends to decrease. When the flow path resistance decreases due to the movement of the movable section 63, the intake volume tends to increase. According to the above configuration, when the exhaust volume is insufficient, the movable section 63 moves so as to decrease the flow path resistance, and thus the temperature in the drying furnace 47 becomes difficult to rise. When the exhaust volume is excessive, the movable section 63 moves so as to increase the flow path resistance, and thus the temperature in the drying furnace 47 becomes difficult to drop.

(3) The cover 64 moves to thereby change the flow path area of the intake port. When the flow path area of the intake port is reduced, it becomes difficult for the air to flow into the drying furnace 47. That is, as the flow path resistance increases, the intake volume tends to decrease. When the flow path area of the intake port increases, it becomes easy for the air to flow into the drying furnace 47. That is, as the flow path resistance decreases, the intake volume tends to increase. According to the above configuration, when the exhaust volume is insufficient, the cover 64 moves so as to increase the flow path area of the intake port, and thus the temperature in the drying furnace 47 becomes difficult to rise. When the exhaust volume is excessive, the cover 64 moves so as to reduce the flow path area of the intake port, and thus the temperature in the drying furnace 47 becomes difficult to drop.

(4) The cover 64 slides in the vertical direction to thereby change the flow path area of the intake port. According to the above configuration, the flow path area of the intake port easily changes. Thus, the intake volume is adjusted.

(5) The controller 62 controls the movable section 63 based on the detection result of the detector 61. According to the above configuration, the movable section 63 appropriately operates based on the state of the drying apparatus 13.

(6) The controller 62 controls the movable section 63 based on the printing information. According to the above configuration, the movable section 63 appropriately operates based on the printing information.

### MODIFIED EXAMPLES

The above embodiment can be implemented with the following modifications. The embodiment described above and the following modified examples can be implemented in combination within a range where no technical contradictions occur.

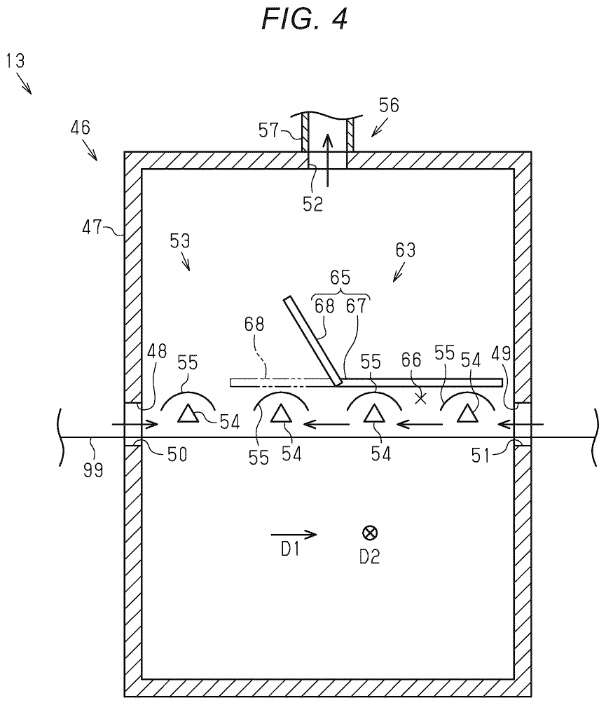

As shown in FIG. 4, the movable section 63 may include a flow guide plate 65. The flow guide plate 65 is located in the drying furnace 47. The flow guide plate 65 is located so as to face the medium 99. For example, the flow guide plate 65 extends along the heater 53. In one example, the flow guide plate 65 extends in an area above the heater 53. Therefore, the heater 53 is located between the medium 99 and the flow guide plate 65.

The flow guide plate 65 guides the air so that the air inflowing from the intake port flows along the medium 99. In one example, the flow guide plate 65 guides the air so that the air inflowing from the second intake port 51 flows along the medium 99. The flow guide plate 65 may guide the air so that the air inflowing from the first intake port 50 flows along the medium 99.

The flow guide plate 65 may define a guide flow path 66 in the drying furnace 47. The guide flow path 66 is a flow path through which the air inflowing from the intake port flows. The guide flow path 66 extends from the intake port. In one example, the guide flow path 66 extends from the second intake port 51. The heater 53 is located in the guide flow path 66. The guide flow path 66 is a flow path that guides the air inflowing from the intake port along the medium 99. The air flows through the guide flow path 66 to thereby pass between the medium 99 and the heater 53.

The flow guide plate 65 has a fixed portion 67. The fixed portion 67 is a portion fixed to the drying furnace 47. The fixed portion 67 is a portion extending from the intake port. In one example, the fixed portion 67 extends linearly from the second intake port 51. The fixed portion 67 extends in parallel to the medium 99.

The flow guide plate 65 includes a movable portion 68. The movable portion 68 is a portion that moves with respect to the fixed portion 67. The movable portion 68 is attached so as to move with respect to the fixed portion 67. In one example, the movable portion 68 is attached to the fixed portion 67 so as to rotate around an end portion of the fixed portion 67. The movable portion 68 moves so as to extend the guide flow path 66. The movable portion 68 moves, for example, between a position where the fixed portion 67 is extended and a position where the movable portion 68 is bent with respect to the fixed portion 67. In FIG. 4, a position indicated by a two-dot chain line is the position where the fixed portion 67 is extended. When the movable portion 68 is located at the position where the fixed portion 67 is extended, the guide flow path 66 extends.

The flow guide plate 65 moves to thereby adjust at least one of the volume and the wind speed of the air which flows along the medium 99 in the drying furnace 47. In this modified example, the flow guide plate 65 moves to thereby change the length of the guide flow path 66. The flow guide plate 65 changes the length of the guide flow path 66 to thereby change a flow rate of the air flowing along the medium 99. When the movable portion 68 is located at the position where the fixed portion 67 is extended, the guide flow path 66 is elongated. When the guide flow path 66 is elongated, the air inflowing from the intake port easily comes into contact with the medium 99. This is because the air inflowing from the intake port becomes difficult to diffuse in the drying furnace 47. Therefore, an amount of the air that comes into contact with the medium 99 increases. In addition, the flow rate of the air flowing along the medium 99 increases. Accordingly, the temperature of the medium 99 is likely to drop. When the movable portion 68 is displaced to the position where the movable portion 68 bends with respect to the fixed portion 67, the guide flow path 66 is shortened. When the guide flow path 66 is shortened, the air inflowing from the intake port becomes difficult to come into contact with the medium 99. Therefore, the amount of the air that comes into contact with the medium 99 is reduced. In addition, the flow rate of the air flowing along the medium 99 decreases. Accordingly, the temperature of the medium 99 is likely to rise.

The flow guide plate 65 moves to thereby change the flow path resistance to the air to be discharged from the drying furnace 47. In this modified example, the flow guide plate 65 changes the length of the guide flow path 66 to thereby change the flow path resistance to the air to be discharged from the drying furnace 47. When the guide flow path 66 is elongated, it becomes difficult for the air to diffuse in the drying furnace 47, and thus the flow path resistance to the air to be discharged increases. Accordingly, the volume and the wind speed of the air flowing along the medium 99 are likely to increase. In this case, the temperature of the medium 99 becomes difficult to rise. When the guide flow path 66 is shortened, the air is easily diffused in the drying furnace 47, and thus the flow path resistance to the air to be discharged is reduced. Accordingly, the volume and wind speed of the air flowing along the medium 99 are likely to decrease. In this case, the temperature of the medium 99 becomes difficult to drop.

When the exhaust volume is insufficient, the volume and the wind speed of the air flowing along the medium 99 tend to decrease, and thus, the temperature of the medium 99 is likely to rise. In contrast, the flow guide plate 65 moves to thereby elongate the guide flow path 66. Accordingly, even when the exhaust volume is insufficient, the volume and the wind speed of the air flowing along the medium 99 are prevented from decreasing, and thus the temperature of the medium 99 becomes difficult to rise. That is, the possibility that the medium 99 is excessively heated is reduced. When the exhaust volume is excessive, the volume and the wind speed of the air flowing along the medium 99 tend to increase, and the temperature of the medium 99 is likely to drop. In contrast, the flow guide plate 65 moves to thereby shorten the guide flow path 66. Accordingly, even when the exhaust volume is excessive, an increase in the volume and the wind speed of the air flowing along the medium 99 is suppressed, and thus the temperature of the medium 99 becomes difficult to drop. That is, the possibility that the drying of the medium 99 becomes insufficient is reduced.

As described in this modified example, the movable section 63 may move to thereby adjust at least one of the volume and the wind speed of the air flowing along the medium 99 in the drying furnace 47. The flow guide plate 65 is not limited to defining the guide flow path 66, and sufficiently has a configuration of guiding the air so as to flow along the medium 99. The flow guide plate 65 sufficiently has a configuration in which the flow guide plate 65 moves to thereby change at least one of the volume and the wind speed of the air flowing along the medium 99. According to this configuration, the medium 99 can be appropriately dried without the cover 64 changing the intake volume and the exhaust volume.

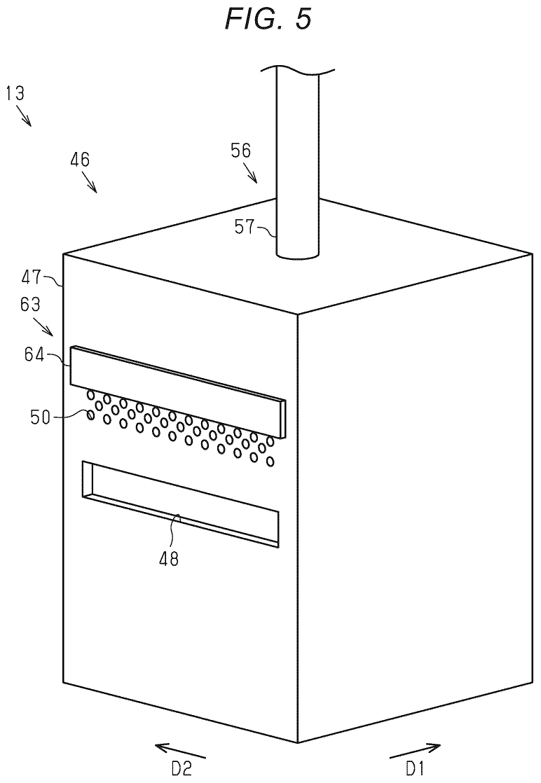

As shown in FIG. 5, the intake port may be an opening different from the passage port. The intake port opens independently of the passage port. Specifically, the first intake port 50 is an opening different from the first passage port 48. The second intake port 51 may be an opening different from the second passage port 49. In this modified example, the first intake port 50 is configured with a plurality of holes that open above the first passage port 48. Since the intake port is an opening different from the passage port, the passage port can be opened in a shape according to the medium 99. For example, the passage port can be opened in a slit shape.

As shown in FIG. 5, the cover 64 may be configured to overlap the intake port that opens independently of the passage port. In this modified example, the cover 64 is located so as to overlap the first intake port 50 that opens independently of the first passage port 48. The cover 64 slides in, for example, the vertical direction to thereby change the flow path area of the first intake port 50. In this case, the possibility that the cover 64 comes into contact with the medium 99 is reduced. The cover 64 may be located so as to change the flow path area of the second intake port 51 that opens independently of the second passage port 49. The movable section 63 may include the cover 64 that changes the flow path area of the first intake port 50 and the cover 64 that changes the flow path area of the second intake port 51.

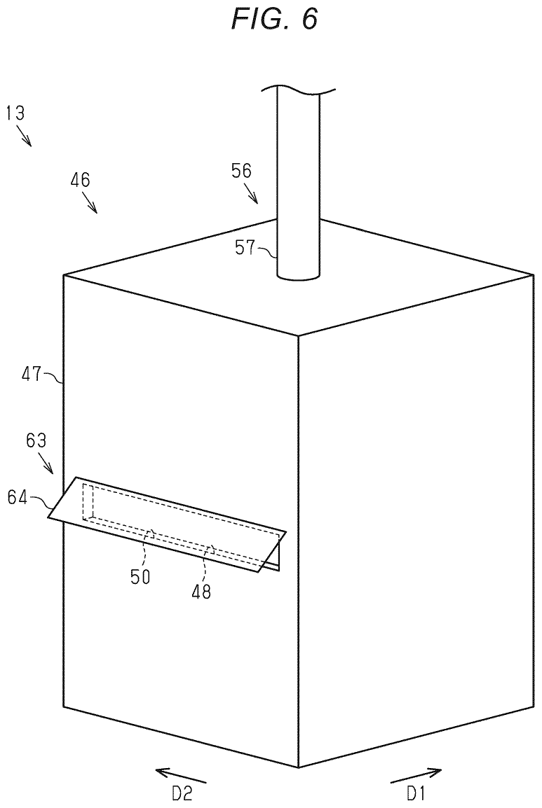

As shown in FIG. 6, the cover 64 may be attached so as to be opened and closed to the drying furnace 47. The cover 64 is opened and closed to thereby change the flow path area of the intake port. The cover 64 is opened and closed by, for example, rotating around an upper end thereof. In this modified example, the cover 64 is attached to the drying furnace 47 so as to overlap the first intake port 50. The cover 64 is opened and closed to thereby change the flow path area of the first intake port 50. The cover 64 may be opened and closed to thereby change the flow path area of the second intake port 51. The movable section 63 may include the cover 64 that is opened and closed to thereby change the flow path area of the first intake port 50, and the cover 64 that is opened and closed to thereby change the flow path area of the second intake port 51.

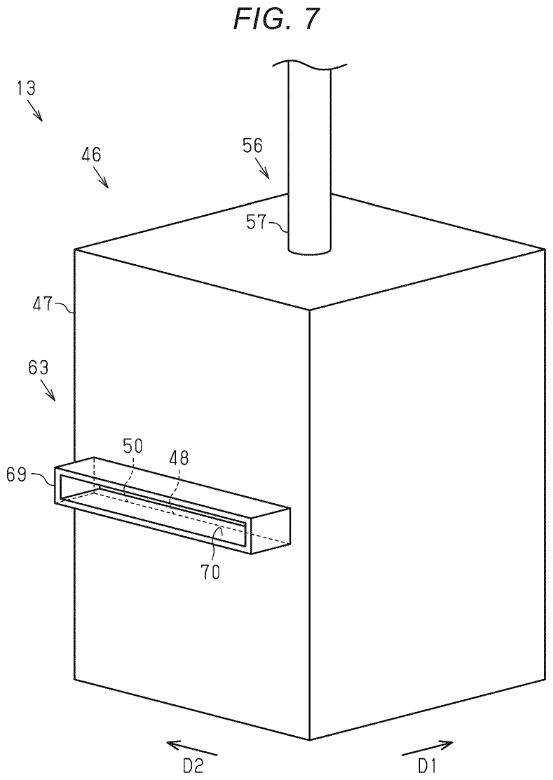

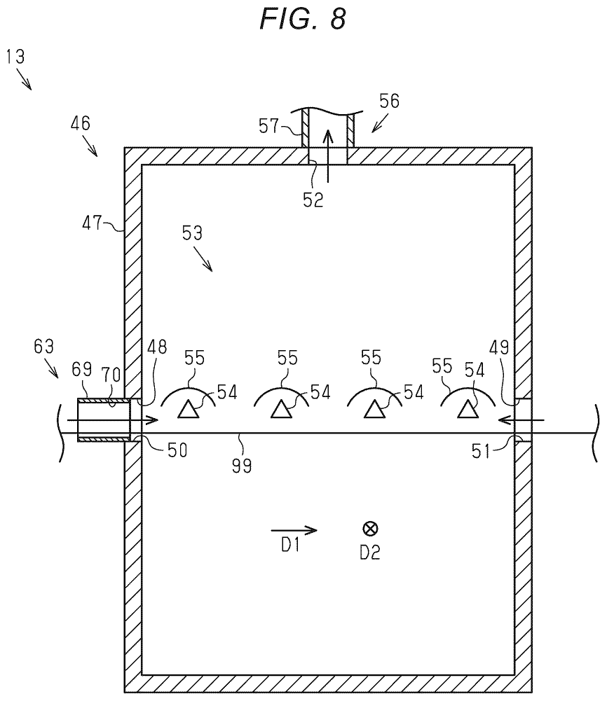

As shown in FIGS. 7 and 8, the movable section 63 may include one or more tubular members 69. The tubular member 69 is a member fitted into the intake port. The tubular member 69 is attached to the drying furnace 47 by being fitted into the intake port. In this modified example, the tubular member 69 is attached so as to be fitted into the first intake port 50. The tubular member 69 may be attached so as to be fitted into the second intake port 51. The movable section 63 may include the tubular member 69 to be attached to the first intake port 50 and the tubular member 69 to be attached to the second intake port 51.

An inflow port 70 is opened in the tubular member 69. The inflow port 70 is an opening through which the air flows from the outside of the drying furnace 47 into the drying furnace 47. The air flows into the drying furnace 47 through the inflow port 70. In this modified example, since the first intake port 50 is an opening common to the first passage port 48, the medium 99 passes through the inflow port 70.

The tubular member 69 is configured to move at the intake port. The tubular member 69 is configured to move at the intake port in the conveyance direction D1 and the opposite direction. The movement of the tubular member 69 changes the volume of the tubular member 69 fitted in the intake port.

The tubular member 69 moves to thereby change the amount of protrusion with respect to the drying furnace 47. The tubular member 69 changes the amount of protrusion with respect to the drying furnace 47 to thereby change the flow path resistance with respect to the air sucked through the intake port. When the amount of protrusion of the tubular member 69 with respect to the drying furnace 47 is small, the air flows into the drying furnace 47 through the inflow port 70. On this occasion, the air flows into the drying furnace 47 while being guided by an inner surface of the tubular member 69 forming the inflow port 70. When the amount of protrusion of the tubular member 69 with respect to the drying furnace 47 is large, the air flows into the drying furnace 47 through the inflow port 70 and the intake port. On this occasion, the air flows into the drying furnace 47 while being guided by the inner surface of the tubular member 69 forming the inflow port 70 and an inner surface of the drying furnace 47 forming the intake port. That is, when the amount of protrusion of the tubular member 69 with respect to the drying furnace 47 is large, the length of the flow path through which the air passes from the outside of the drying furnace 47 until the air enters the drying furnace 47 increases. Therefore, when the amount of protrusion of the tubular member 69 with respect to the drying furnace 47 is large, the flow path resistance to the air flowing into the drying furnace 47 increases. Therefore, when the tubular member 69 protrudes from the drying furnace 47, the intake volume tends to decrease. When the amount of protrusion of the tubular member 69 with respect to the drying furnace 47 is small, the flow path resistance decreases, and thus the intake volume tends to increase. In this way, the intake volume is adjusted by the amount of protrusion of the tubular member 69.

When the exhaust volume is insufficient, the tubular member 69 moves to thereby decrease the amount of protrusion with respect to the drying furnace 47. Accordingly, the temperature in the drying furnace 47 becomes difficult to rise. When the exhaust volume is excessive, the tubular member 69 moves to thereby increase the amount of protrusion with respect to the drying furnace 47. Accordingly, the temperature in the drying furnace 47 becomes difficult to drop.

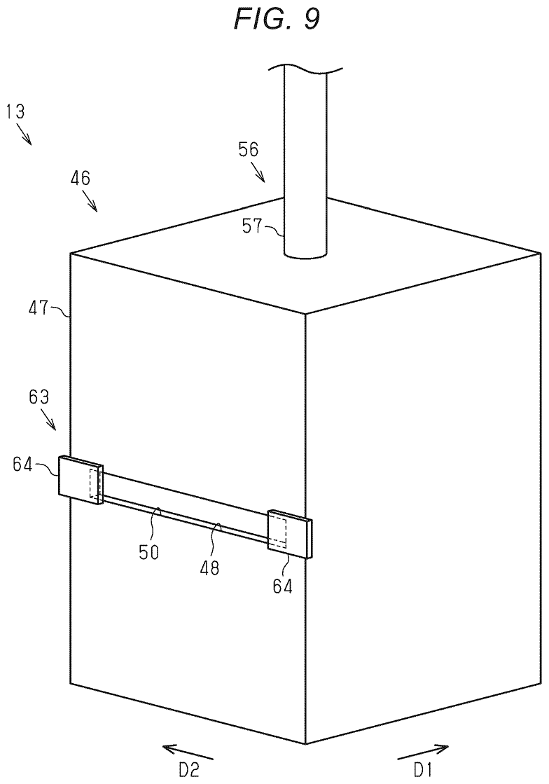

As shown in FIG. 9, the cover 64 may be configured to slide in the width direction D2. The cover 64 is located so as to overlap the intake port. The cover 64 slides to thereby change the flow path area of the intake port. The movable section 63 may include a plurality of covers 64. In this modified example, the movable section 63 includes two covers 64 overlapping the first intake port 50. The two covers 64 may be configured to move in conjunction with each other. For example, the two covers 64 may move so as to come closer to each other or to get away from each other in the width direction D2. By the two covers 64 moving so as to come closer to each other, the flow path area of the intake port is reduced. The two covers 64 can narrow the width of the intake port in accordance with the width of the medium 99. The covers 64 may be located so as to overlap the second intake port 51. The movable section 63 may include one or more covers 64 overlapping the first intake port 50 and one or more covers 64 overlapping the second intake port 51.

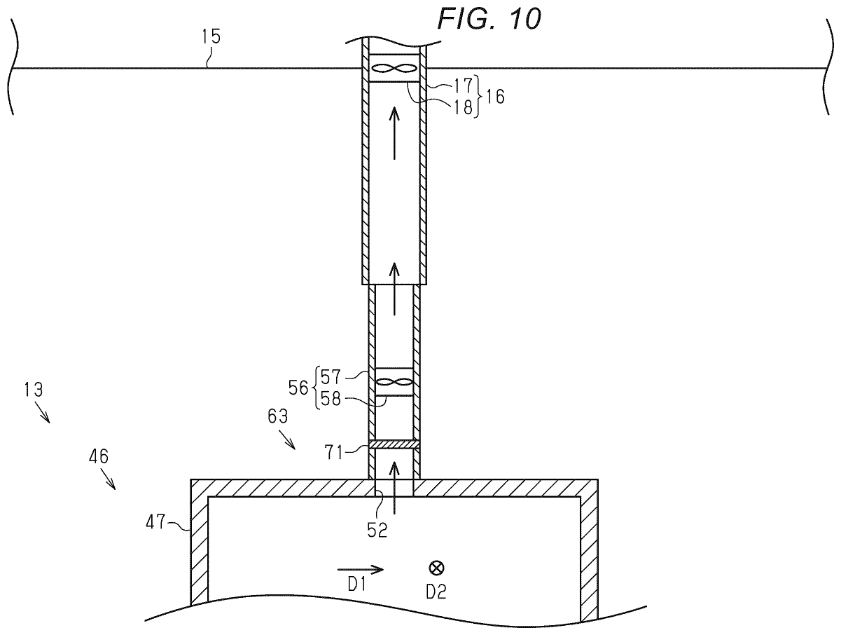

As shown in FIG. 10, the movable section 63 may include a shutter member 71. The shutter member 71 is attached to the duct 57. In this modified example, the shutter member 71 is located between the exhaust port 52 and the fan 58 in the duct 57. The shutter member 71 may be located between the fan 58 and the exhaust mechanism 16 in the duct 57.

The shutter member 71 moves to thereby change the flow path area of the duct 57. The shutter member 71 changes the flow path area of the duct 57 to thereby change the flow path resistance to the air exhausted through the exhaust port 52. The shutter member 71 changes the flow path area of the duct 57 to thereby change how easy it is to exhaust the air. The shutter member 71 may be configured to open and close the duct 57.

When the exhaust volume is insufficient, the shutter member 71 increases the flow path area of the duct 57. As a result, the exhaust volume tends to increase. Therefore, the temperature in the drying furnace 47 becomes difficult to rise. When the exhaust volume is excessive, the shutter member 71 reduces the flow path area of the duct 57. As a result, the exhaust volume tends to decrease. Therefore, the temperature in the drying furnace 47 becomes difficult to drop.

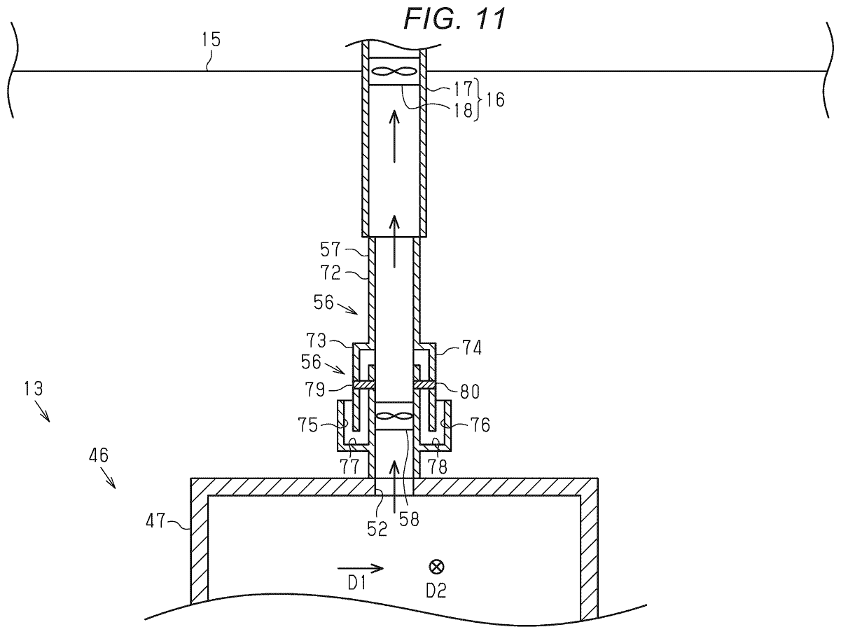

As shown in FIG. 11, the duct 57 may have a main body portion 72. The main body portion 72 is a portion extending from the drying furnace 47. The main body portion 72 is coupled to the drying furnace 47. The main body portion 72 communicates with the exhaust port 52. The main body portion 72 is coupled to the exhaust mechanism 16. The fan 58 is located in the main body portion 72.

The duct 57 may have one or more branch portions. In this modified example, the duct 57 has two branch portions. Specifically, the duct 57 includes a first branch portion 73 and a second branch portion 74. The branch portion is a portion branched from the main body portion 72. The branch portion branches from an area between the fan 58 and the exhaust mechanism 16 in the main body portion 72, for example. That is, the fan 58 is located between the branch portion and the drying furnace 47 in the main body portion 72. The branch portion extends in the factory 15. In one example, the branch portion extends downward from the main body portion 72 and then bends so as to extend upward.

A branch port opens in the branch portion. Specifically, a first branch port 75 opens in the first branch portion 73. A second branch port 76 opens in the second branch portion 74. The branch port is an opening through which the air enters and exits. The branch port communicates with the inside of the factory 15. The branch portion sucks and exhausts the air through the branch port.

The duct 57 sucks the air into the main body portion 72 through the branch portion or exhausts the air from the main body portion 72 through the branch portion in accordance with a difference between an air blowing amount by the fan 58 and an air blowing amount by the exhaust fan 18. Normally, the air blowing amount by the exhaust fan 18 can be larger than the air blowing amount by the fan 58. In this case, the exhaust the air from the drying apparatus 13 to the outside of the factory 15 becomes smooth.

When the air blowing amount by the exhaust fan 18 is smaller than the air blowing amount by the fan 58, there is a possibility that the exhaust the air from the exhaust section 56 to the exhaust mechanism 16 stagnates. When the exhaust the air from the exhaust section 56 to the exhaust mechanism 16 stagnates, there is a possibility that the exhaust volume from the drying furnace 47 becomes insufficient. In contrast, in this modified example, when the air blowing amount by the exhaust fan 18 is smaller than the air blowing amount by the fan 58, that is, when there is a possibility that the exhaust volume becomes insufficient, the air flows from the main body portion 72 to the branch portion. That is, the exhaust section 56 exhausts the air from the branch port. The fan 58 sends the air discharged from the drying furnace 47 to the exhaust mechanism 16 and the branch portion. This reduces the possibility that the exhaust volume becomes insufficient.

When the air blowing amount by the exhaust fan 18 is excessively larger than the air blowing amount by the fan 58, there is a possibility that the exhaust volume from the drying furnace 47 becomes excessive. In contrast, in this modified example, when the air blowing amount by the exhaust fan 18 is excessively larger than the air blowing amount by the fan 58, that is, when there is a possibility that the exhaust volume is excessive, the air flows from the branch portion to the main body portion 72. That is, the exhaust section 56 sucks the air through the branch port. The fan 58 sends the air to be discharged from the drying furnace 47 to the exhaust mechanism 16 together with the air flowing into the main body portion 72 through the branch portion. This reduces the possibility that the exhaust volume becomes excessive.

As shown in FIG. 11, the branch portion may have a trap portion. Specifically, the first branch portion 73 may have a first trap portion 77. The second branch portion 74 may have a second trap portion 78. The trap portion is a portion that receives the liquid. The trap portion is a portion which is a part of the branch portion and is bent so as to protrude downward. The exhaust air flowing through the main body portion 72 may be cooled in some cases in the process of flowing through the branch portion. In this case, the vapor is liquefied in the branch portion. The liquid thus liquefied accumulates in the trap portion. By the trap portion storing the liquid thus liquefied, the amount of vapor discharged through the branch port is reduced. When the branch portion does not have the trap portion, there is a possibility that the vapor is directly discharged into the factory 15. Further, when the branch portion does not have the trap portion, there is a possibility that the liquid thus liquefied drips from the branch port or flows into the main body portion 72.

As shown in FIG. 11, the movable section 63 may include one or more opening-closing members. In this modified example, the movable section 63 includes two opening-closing members. Specifically, the movable section 63 includes a first opening-closing member 79 and a second opening-closing member 80. The opening-closing member is located in the branch portion. The first opening-closing member 79 is located in the first branch portion 73. The second opening-closing member 80 is located in the second branch portion 74.

The opening-closing member is configured to open and close the branch portion. The first opening-closing member 79 is configured to open and close the first branch portion 73. The second opening-closing member 80 is configured to open and close the second branch portion 74. The first opening-closing member 79 and the second opening-closing member 80 may move in conjunction with each other or may move so as to open and close the corresponding branch portions independently of each other. The opening-closing member may be configured to change the flow path area of the branch portion.

The opening-closing member adjusts the exhaust volume by opening and closing the branch portion. When the opening-closing member opens and closes the branch portion, the flow path resistance to the air exhausted through the exhaust port 52 changes. When the flow path resistance changes, how easy it is to exhaust the air changes. In this way, the opening-closing member adjusts the exhaust volume.

The opening-closing member opens and closes the branch portion in accordance with the difference between the air blowing amount by the fan 58 and the air blowing amount by the exhaust fan 18. When the air blowing amount by the exhaust fan 18 is smaller than the air blowing amount by the fan 58, when the air blowing amount by the exhaust fan 18 is excessively larger than the air blowing amount by the fan 58, or the like, the opening-closing member opens the branch portion. That is, when the exhaust volume is excessive or insufficient, the opening-closing member opens the branch portion. When the opening-closing member opens the branch portion, the exhaust volume of the air discharged from the exhaust port 52 is adjusted. For example, when the exhaust the air from the drying furnace 47 stagnates, that is, when the exhaust volume is insufficient, the opening-closing member opens the branch portion, so that the air is exhausted from the branch port. By the air being exhausted from the branch port, the exhaust volume from the drying furnace 47 increases. When the exhaust the air from the drying furnace 47 is excessive, that is, when the exhaust volume is excessive, the opening-closing member opens the branch portion, so that the air is sucked from the branch port. The exhaust volume from the drying furnace 47 is decreased by the air being sucked from the branch port.

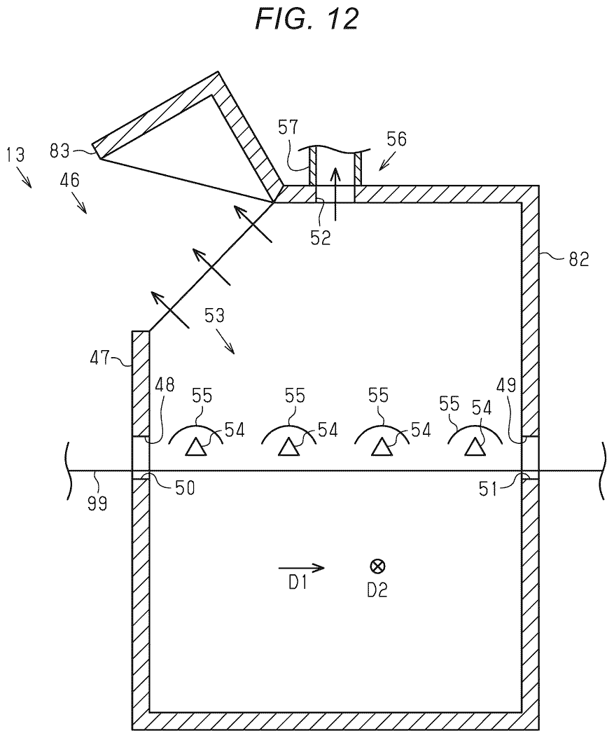

As shown in FIG. 12, the drying furnace 47 may have a first portion 82 and a second portion 83. The second portion 83 is attached to the first portion 82 so as to be opened and closed. The second portion 83 is opened with respect to the first portion 82 to expose the inside of the drying furnace 47. The second portion 83 may be automatically opened and closed by the controller 62 or may be manually opened and closed by the user.

When the conveyer 32 stops due to jamming of the medium 99, an error in printing, or the like, the medium 99 stops in the drying furnace 47. In this case, there is a possibility that the medium 99 is excessively heated in the drying furnace 47. Therefore, in the drying unit 46, the second portion 83 opens when the conveyer 32 stops. As a result, the temperature in the drying furnace 47 rapidly drops. Therefore, the possibility that the medium 99 is excessively heated is reduced. When the conveyer 32 stops, the heater 53 may stop.

The drying apparatus 13 may be configured integrally with the printing apparatus 12. For example, the drying apparatus 13 may include the printing section 27. In this case, the drying furnace 47 may be configured such that the heat from the heater 53 is difficult to be transferred to the printing section 27.

### Technical Ideas

Technical ideas figured out from the embodiment and the modified examples described above, and the functions and advantages thereof will hereinafter be described.

(A) A drying apparatus includes a drying furnace which a medium to be conveyed enters, a heater configured to heat the medium in the drying furnace, an exhaust section configured to exhaust air from the drying furnace, and a movable section configured to move, wherein an intake port through which air flows from the outside of the drying furnace into the drying furnace opens in the drying furnace, the exhaust section includes a duct extending from the drying furnace and a fan configured to exhaust the air from the inside of the drying furnace toward the outside of the drying furnace through the duct, and the movable section moves to thereby adjust at least one of an intake volume of the air inflowing through the intake port and an exhaust volume of the air discharged from the drying furnace. When the intake volume changes or the exhaust volume changes, the temperature in the drying furnace rises or drops. For example, when the intake volume increases, the temperature in the drying furnace tends to drop. When the intake volume decreases, the temperature in the drying furnace tends to rise. When the exhaust volume increases, the temperature in the drying furnace tends to drop. When the exhaust volume decreases, the temperature in the drying furnace tends to rise. According to the above configuration, when the exhaust volume is insufficient, by the movable section moving so as to increase the intake volume or increase the exhaust volume, the temperature in the drying furnace becomes difficult to rise. When the exhaust volume is excessive, by the movable section moving so as to decrease the intake volume or decrease the exhaust volume, the temperature in the drying furnace becomes difficult to drop. Accordingly, the drying apparatus can appropriately dry the medium.

(B) In the drying apparatus, the movable section may move to thereby change a flow path resistance to the air inflowing from the intake port. When the flow path resistance increases due to the movement of the movable section, the intake volume tends to decrease. When the flow path resistance decreases due to the movement of the movable section, the intake volume tends to increase. According to the above configuration, when the exhaust volume is insufficient, by the movable section moving so as to reduce the flow path resistance, the temperature in the drying furnace becomes difficult to rise. When the exhaust volume is excessive, by the movable section moving so as to increase the flow path resistance, the temperature in the drying furnace becomes difficult to drop.

(C) In the drying apparatus, the movable section may include a tubular member attached to the drying furnace so as to be fitted into the intake port, an inflow port through which the air flows from the outside of the drying furnace into the drying furnace may open in the tubular member, and the tubular member may move to thereby change an amount of protrusion with respect to the drying furnace. When the amount of protrusion of the tubular member with respect to the drying furnace increases, a flow path of the air flowing from the outside of the drying furnace into the drying furnace elongates, so that the air becomes difficult to flow into the drying furnace. That is, as the flow path resistance increases, the intake volume tends to decrease. When the amount of protrusion of the tubular member with respect to the drying furnace decreases, the flow path of the air flowing from the outside of the drying furnace into the drying furnace shortens, so that the air becomes easy to flow into the drying furnace. That is, as the flow path resistance decreases, the intake volume tends to increase. According to the above configuration, when the exhaust volume is insufficient, by the tubular member moving so as to reduce the amount of protrusion, the temperature in the drying furnace becomes difficult to rise. When the exhaust volume is excessive, by the tubular member moving so as to increase the amount of protrusion, the temperature in the drying furnace becomes difficult to drop.

(D) In the drying apparatus, the movable section may include a cover to be attached to the drying furnace, and the cover may move to thereby change a flow path area of the intake port. When the flow path area of the intake port is reduced, the air becomes difficult to flow into the drying furnace. That is, as the flow path resistance increases, the intake volume tends to decrease. When the flow path area of the intake port increases, it becomes easy for the air to flow into the drying furnace. That is, as the flow path resistance decreases, the intake volume tends to increase. According to the above configuration, when the exhaust volume is insufficient, the cover moves so as to increase the flow path area of the intake port, and thus the temperature in the drying furnace becomes difficult to rise. When the exhaust volume is excessive, the cover moves so as to reduce the flow path area of the intake port, and thus the temperature in the drying furnace becomes difficult to drop.

(E) In the drying apparatus, the cover may slide in a vertical direction to thereby change the flow path area of the intake port. According to the above configuration, the flow path area of the intake port easily changes.

(F) In the drying apparatus, the cover may slide in a width direction different from the vertical direction to thereby change the flow path area of the intake port. According to the above configuration, the flow path area of the intake port easily changes.

(G) In the drying apparatus, the cover may be opened and closed to thereby change the flow path area of the intake port. According to the above configuration, the flow path area of the intake port can be easily changed.

(H) In the drying apparatus, the movable section may be configured to move to thereby change a flow path resistance to the air discharged from the drying furnace by the exhaust section. When the flow path resistance increases due to the movement of the movable section, the exhaust volume tends to decrease. When the flow path resistance decreases due to the movement of the movable section, the exhaust volume tends to increase. According to the above configuration, when the exhaust volume is insufficient, by the movable section moving so as to reduce the flow path resistance, the temperature in the drying furnace becomes difficult to rise. When the exhaust volume is excessive, by the movable section moving so as to increase the flow path resistance, the temperature in the drying furnace becomes difficult to drop.

(I) A drying apparatus includes a drying furnace which a medium to be conveyed enters, a heater configured to heat the medium in the drying furnace, an exhaust section configured to exhaust air from the drying furnace, and a movable section configured to move, wherein an intake port through which air flows from the outside of the drying furnace into the drying furnace opens in the drying furnace, the exhaust section includes a duct extending from the drying furnace and a fan configured to exhaust the air from the inside of the drying furnace toward the outside of the drying furnace through the duct, and the movable section moves to thereby adjust at least one of a volume and a wind speed of air flowing along the medium in the drying furnace. When the volume of the air flowing along the medium changes or the wind speed thereof changes, the temperature of the medium rises or drops. For example, when the volume of the air flowing increases or the wind speed increases, the temperature of the medium tends to drop. When the volume of the air flowing decreases or the wind speed decreases, the temperature of the medium tends to rise. When the exhaust volume increases, the temperature in the drying furnace tends to drop. In this case, there is a possibility that drying of the medium becomes insufficient. When the exhaust volume decreases, the temperature in the drying furnace tends to rise. In this case, there is a possibility that drying of the medium becomes excessive. According to the above configuration, when the exhaust volume is insufficient, by the movable section moving so as to increase the volume of the air flowing or increase the wind speed, the temperature of the medium becomes difficult to rise. When the exhaust volume is excessive, by the movable section moving so as to reduce the volume of the air flowing or the wind speed, the temperature of the medium becomes difficult to drop. Accordingly, the drying apparatus can appropriately dry the medium.

(J) In the drying apparatus, the heater may be located so as to face the medium, the movable section may include a flow guide plate configured to guide the air inflowing from the intake port to flow along the medium, and the flow guide plate may move to thereby change at least one of the volume and the wind speed of the air flowing along the medium in the drying furnace. According to the above configuration, when the exhaust volume is insufficient, by the flow guide plate moving such that at least one of the volume and the wind speed of the air flowing along the medium increases, the temperature of the medium becomes difficult to increase. When the exhaust volume is excessive, by the flow guide plate moving such that at least one of the volume and the wind speed of the air flowing along the medium decreases, the temperature of the medium becomes difficult to drop.

(K) In the drying apparatus, the movable section may include a shutter member configured to move to thereby change a flow path area of the duct. When the flow path area of the duct increases, the air is easily exhausted from the drying furnace. That is, the flow path resistance to the air to be exhausted is reduced, and thus the exhaust volume is likely to increase. When the flow path area of the duct is reduced, the air becomes difficult to be exhausted from the drying furnace. That is, the flow path resistance to the air to be exhausted is increased, and thus the exhaust volume is likely to decrease. According to the above configuration, when the exhaust volume is insufficient, by the shutter member moving so as to increase the flow path area of the duct, the temperature in the drying furnace becomes difficult to rise. When the exhaust volume is excessive, by the shutter member moving so as to reduce the flow path area of the duct, the temperature in the drying furnace becomes difficult to drop.

(L) In the drying apparatus, the duct may include a main body portion extending from the drying furnace and a branch portion branching from the main body portion, the fan may be located between the branch portion and the drying furnace in the main body portion, a branch port through which air enters and exits may open in the branch portion, and the movable section may include an opening-closing member configured to open and close the branch portion. According to the above configuration, when the exhaust volume is insufficient, by the opening-closing member opening the branch portion, the air is sucked from the branch port. Since the exhaust volume from the drying furnace is decreased by sucking the air from the branch port, the temperature in the drying furnace becomes difficult to drop. When the exhaust volume is excessive, by the opening-closing member opening the branch portion, the air is exhausted from the branch port. Since the exhaust volume from the drying furnace increases by exhausting the air from the branch port, the temperature in the drying furnace becomes difficult to rise. In this way, the excess or deficiency of the exhaust volume is eliminated by opening the branch portion.

(M) In the drying apparatus, the branch portion may be a first branch portion, the duct may include a second branch portion branching from the main body portion, the opening-closing member may be a first opening-closing member, and the movable section may include a second opening-closing member located in the second branch portion. According to the above configuration, since the first opening-closing member opens the first branch portion and the second opening-closing member opens the second branch portion, the excess or deficiency of the exhaust volume is easily eliminated.

(N) In the drying apparatus, the branch portion may have a trap portion configured to receive a liquid. In the branch portion, vapor may be liquefied by being cooled in the process of flowing in some cases. According to the above configuration, by the trap portion storing the liquid thus liquefied, an amount of the vapor discharged through the branch port is reduced.

(O) In the drying apparatus, a passage port through which the medium passes may open in the drying furnace, and the intake port may be an opening different from the passage port. According to the above configuration, a possibility that the movable section comes into contact with the medium is reduced.

(P) The drying apparatus may include a detector configured to detect a state of the drying apparatus, and a controller configured to control the movable section based on a detection result of the detector. According to the above configuration, it is possible to appropriately operate the movable section based on the state of the drying apparatus.

(Q) The drying apparatus may include a controller configured to receive printing information from a printing apparatus that prints an image on the medium, wherein the controller may control the movable section based on the printing information. According to the above configuration, it is possible to appropriately operate the movable section based on the printing information.

(R) A printing apparatus includes a printing section configured to print an image on a medium, a drying furnace which the medium printed enters, a heater configured to heat the medium in the drying furnace, an exhaust section configured to exhaust air from the drying furnace, and a movable section configured to move, wherein an intake port through which air flows from the outside of the drying furnace into the drying furnace opens in the drying furnace, the exhaust section includes a duct extending from the drying furnace and a fan configured to exhaust the air from the inside of the drying furnace toward the outside of the drying furnace through the duct, and the movable section moves to thereby adjust at least one of an intake volume of the air inflowing through the intake port and an exhaust volume of the air discharged from the drying furnace. According to the above configuration, substantially the same advantages as those of the drying apparatus described above can be obtained.

(S) A printing apparatus includes a printing section configured to print an image on a medium, a drying furnace which the medium printed enters, a heater configured to heat the medium in the drying furnace, an exhaust section configured to exhaust air from the drying furnace, and a movable section configured to move, wherein an intake port through which air flows from the outside of the drying furnace into the drying furnace opens in the drying furnace, the exhaust section includes a duct extending from the drying furnace and a fan configured to exhaust the air from the inside of the drying furnace toward the outside of the drying furnace through the duct, and the movable section moves to thereby adjust at least one of a volume and a wind speed of air flowing along the medium in the drying furnace. According to the above configuration, substantially the same advantages as those of the drying apparatus described above can be obtained.

What is claimed is:

1. A drying apparatus comprising:
a drying furnace which a medium to be conveyed enters;
a heater configured to heat the medium in the drying furnace;
an exhaust section configured to exhaust air from the drying furnace; and
a movable section configured to move, wherein
an intake port through which air flows from an outside of the drying furnace into the drying furnace opens in the drying furnace,
the exhaust section includes
a duct extending from the drying furnace and
a fan configured to exhaust the air from an inside of the drying furnace toward the outside of the drying furnace through the duct, and
the movable section moves to thereby adjust at least one of an intake volume of the air inflowing through the intake port and an exhaust volume of the air discharged from the drying furnace.

2. The drying apparatus according to claim 1, wherein
the movable section moves to thereby change a flow path resistance to the air inflowing from the intake port.

3. The drying apparatus according to claim 2, wherein
the movable section includes a tubular member attached to the drying furnace so as to be fitted into the intake port,
an inflow port through which the air flows from the outside of the drying furnace into the drying furnace opens in the tubular member, and
the tubular member moves to thereby change an amount of protrusion with respect to the drying furnace.

4. The drying apparatus according to claim 2, wherein
the movable section includes a cover to be attached to the drying furnace, and
the cover moves to thereby change a flow path area of the intake port.

5. The drying apparatus according to claim 4, wherein
the cover slides in a vertical direction to thereby change the flow path area of the intake port.

6. The drying apparatus according to claim 4, wherein
the cover slides in a width direction different from a vertical direction to thereby change the flow path area of the intake port.

7. The drying apparatus according to claim 4, wherein
the cover is opened and closed to thereby change the flow path area of the intake port.

8. The drying apparatus according to claim 1, wherein
the movable section is configured to move to thereby change a flow path resistance to the air discharged from the drying furnace by the exhaust section.

9. A drying apparatus comprising:
a drying furnace which a medium to be conveyed enters;
a heater configured to heat the medium in the drying furnace;
an exhaust section configured to exhaust air from the drying furnace; and
a movable section configured to move, wherein
an intake port through which air flows from an outside of the drying furnace into the drying furnace opens in the drying furnace,
the exhaust section includes
a duct extending from the drying furnace and
a fan configured to exhaust the air from an inside of the drying furnace toward the outside of the drying furnace through the duct, and
the movable section moves to thereby adjust at least one of a volume and a wind speed of air flowing along the medium in the drying furnace.

10. The drying apparatus according to claim 9, wherein
the heater is located so as to face the medium,
the movable section includes a flow guide plate configured to define a guide flow path for guiding the air inflowing from the intake port to flow along the medium, and
the flow guide plate moves to thereby adjust at least one of a volume and a wind speed of the air flowing along the medium in the drying furnace.

11. The drying apparatus according to claim 8, wherein
the movable section includes a shutter member configured to move to thereby change a flow path area of the duct.

12. The drying apparatus according to claim 1, wherein
the duct includes
a main body portion extending from the drying furnace and
a branch portion branching from the main body portion,
the fan is located between the branch portion and the drying furnace in the main body portion,
a branch port through which air enters and exits opens in the branch portion, and
the movable section includes an opening-closing member configured to open and close the branch portion.

13. The drying apparatus according to claim 12, wherein
the branch portion is a first branch portion,
the duct includes a second branch portion branching from the main body portion,
the opening-closing member is a first opening-closing member, and
the movable section includes a second opening-closing member located in the second branch portion.

14. The drying apparatus according to claim 12, wherein
the branch portion has a trap portion configured to receive a liquid.

15. The drying apparatus according to claim 1, wherein
a passage port through which the medium passes opens in the drying furnace, and
the intake port is an opening different from the passage port.

16. The drying apparatus according to claim 1, further comprising:
a detector configured to detect a state of the drying apparatus; and
a controller configured to control the movable section based on a detection result of the detector.

17. The drying apparatus according to claim 1, further comprising:
a controller configured to receive printing information from a printing apparatus that prints an image on the medium, wherein
the controller controls the movable section based on the printing information.

18. A printing apparatus comprising:
a printing section configured to print an image on a medium;
a drying furnace which the medium printed enters;
a heater configured to heat the medium in the drying furnace;
an exhaust section configured to exhaust air from the drying furnace; and
a movable section configured to move, wherein
an intake port through which air flows from an outside of the drying furnace into the drying furnace opens in the drying furnace,
the exhaust section includes
a duct extending from the drying furnace and
a fan configured to exhaust the air from an inside of the drying furnace toward the outside of the drying furnace through the duct, and
the movable section moves to thereby adjust at least one of an intake volume of the air inflowing through the intake port and an exhaust volume of the air discharged from the drying furnace.

19. A printing apparatus comprising:
a printing section configured to print an image on a medium;
a drying furnace which the medium printed enters;
a heater configured to heat the medium in the drying furnace;
an exhaust section configured to exhaust air from the drying furnace; and
a movable section configured to move, wherein
an intake port through which air flows from an outside of the drying furnace into the drying furnace opens in the drying furnace,
the exhaust section includes
a duct extending from the drying furnace and
a fan configured to exhaust the air from an inside of the drying furnace toward the outside of the drying furnace through the duct, and
the movable section moves to thereby adjust at least one of a volume and a wind speed of air flowing along the medium in the drying furnace.
